(19) United States
(12) Patent Application Publication
(10) Pub. No.: US 2005/0277410 A1
(43) Pub. Date: Dec. 15, 2005

(54) Automated voice link initiation

(75) Inventors: Samir Ismail, Dublin, CA (US); Tadamasa Kitsukawa, Cupertino, CA (US)

Correspondence Address: CARPENTER & KULAS, LLP, 1900 EMBARCADERO ROAD, SUITE 109, PALO ALTO, CA, 94303, US

(73) Assignee: Sony Corporation and Sony Electronics, Inc.

(21) Appl. No.: 10/866,432

(22) Filed: Jun. 10, 2004

(51) Int. Cl. H04Q 7/20

(52) U.S. Cl. 455/426.2

(57) ABSTRACT

A mobile device such as a mobile phone provides automated initiation of a voice link based on information obtained from a data link communication. In one embodiment a transaction is initiated via a data link by executing a client process in a user's mobile device. The client process obtains information, such as item names and prices, from a content server. The client process presents the items for selection using the mobile device's user interface. The user makes a selection of items for purchase by interacting with the client process and/or the content server. Once a selection has been made, the user is put in voice-to-voice telephone communication with a human agent at a CSR site that handles sales of the item or items that the user selected. Automation at the CSR obtains the user's caller ID and uses the caller ID to request the record of selected items from the content server. The CSR agent is shown the record and is then able to complete the transaction with the user over the voice link.

### BACKGROUND OF THE INVENTION

This invention is related in general to telecommunications systems and more specifically to automated initiation of a voice link.

Portable telecommunications devices such as mobile phones, personal digital assistants (PDAs), etc., are being used more frequently as wireless Internet access devices. For example, such portable devices are often used to view web pages to obtain or provide information to make purchases, send messages, manage records and perform other tasks. Although the ability to perform a transaction at virtually any time and location can be a great convenience, there are also drawbacks in adapting portable devices and mobile telecommunications technology to mobile transactions.

For example, the wireless service providers only allow very limited purchase amounts (e.g., up to $4) to be charged to a user's mobile telephone number or mobile identification number (MIN). One way to allow a user to make a purchase at a higher price is to obtain a user's credit card number and user profile or identity information. However, the very small user interface (e.g., display screen, 12-key keypad and few additional buttons) provided by most portable communications devices can make it very difficult to query a user and to allow a user to input the required information. Further, it is often difficult to present a user with enough information quickly and intelligibly so that the user can comfortably make a spontaneous purchase with a mobile device.

Prior to presenting a user with items or services for purchase a content or service provider will typically first determine the user's interests. This is often achieved by providing the user with many menu selections, web page offerings, or other narrowing levels of user selection until a specific item for purchase is identified. Often a user may not have a specific purchase in mind but rather has a general need to obtain a type of product or service. For example, a user may desire to buy an audio playback device, tickets to an event, etc. In some cases a user may not be aware at a given point in time that they will need or want to make a purchase in the near future. The service provider typically does not know enough about the user to predict the user's future purchase needs without direct participation by the user.

Typically, a web page or distilled (i.e., compacted) web page is provided by a content server when a user accesses the content server's site. The web page can be provided over a wireless data link using a data transfer protocol such as General Packet Radio Service (GPRS). The web page is displayed to the user on a very small display as, for example, on a user's mobile phone display screen. Often a user will be frustrated trying to view web page information made for a much larger display format (e.g., for a personal computer monitor) on a small screen. User frustration can be compounded if the user has to type required information, especially non-numeric information, using the limited user input controls of the small portable device. In such cases the user may never complete the transaction.

Another concern is that much of the existing remote purchasing infrastructure is based on person-to-person telephone conversation (“voice-to-voice”). For many companies, a Customer Service Representative call center or site (collectively the “CSR”) employs a human CSR agent who speaks over the phone to a user or purchaser in order to help the user decide what items to purchase. The CSR agent obtains user information and completes the transaction. Usually this requires several or many questions back-and-forth between the user and the CSR agent. For example, if a user desires to make a ticket purchase for an event the user will ask what seat locations are available, whether multiple seats are together, the price of the tickets, etc. The CSR agent might ask the user what day/time they would like to attend the event, how many tickets to purchase, how the tickets should be provided, etc.

The voice-to-voice transaction works well in many situations and also usually provides a user with a higher confidence or trust level that their information will be kept confidential and that the business entity with which they are dealing is viable and trustworthy. Voice-to-voice also provides the CSR with confidence that the user is viable and trustworthy. Additional technology such as caller identification (“caller ID”), use of a Mobile Identification Number (MIN), pre-storing a user profile in a database, etc., can also improve the efficiency and reliability of the transaction. However, a drawback of voice-to-voice transactions is that it is time-consuming and costly to dedicate an agent for many transactions throughout the entire course of the transaction from start to finish.

### BRIEF SUMMARY OF THE INVENTION

A preferred embodiment of the invention allows automated initiation of a voice link from information obtained from a data link communication. In one embodiment a transaction is initiated via a data link by executing a client process in a user's mobile device. The client process obtains information, such as item names and prices, from a content server. The client process presents the items for selection using the mobile device's user interface. The user makes a selection of items for purchase by interacting with the client process and/or the content server.

Once a selection has been made, the user is put in voice-to-voice telephone communication with a CSR agent at a CSR that handles sales of the item or items that the user selected. Automation at the CSR obtains the user's caller ID or MIN and uses the caller ID or MIN to request the record of selected items from the content server. The CSR agent is shown the record and is then able to complete the transaction with the user over the voice link.

Other embodiments allow for different levels of automation and other possible variations. For example, the user can define a profile that is accessed by the client process, the content server or the CSR. The automated voice link initiation can be performed by the client process without user participation after the user has affirmed a desire to make a purchase. In another embodiment, the user's mobile device can be provided with a dedicated button or other control that is used to indicate the user's desire to purchase items that are selected via the data link. For example, the user can select items for purchase by checking boxes on a Hyper Text Markup Language (HTML) web page. The user can then initiate transfer to a CSR corresponding to the selected items by pressing the dedicated button. The data link provides the CSR phone number to the mobile device and the mobile device can use the phone number to make the voice link connection as a standard call within, e.g., a cellular phone network.

In another embodiment the invention allows a product or service provider to assess a user's possible future needs by examining user information. For example, a user's calendar or scheduling software can be resident on the user's portable device. The device can send the scheduler information to the service provider and the service provider can analyze the user's upcoming scheduled events in order to suggest purchases. For example, if a user's schedule shows that the user will be in a specific city at a specific time then the provider can suggest a product or event purchase for the user appropriate to the future place and/or time. In a preferred embodiment, a user's calendar information is analyzed by a content server process. If open timeslots in the user's calendar are detected then an icon is placed in the calendar. When the user selects the icon, more information about a suggested purchase (e.g., tickets for an entertainment event) are displayed and the user can make the suggested purchase as desired.

In one embodiment the invention provides a method for initiating a voice link in a wireless device, the method comprising establishing a data link between the wireless device and a station; receiving a machine-readable voice link address from the station to the wireless device over the data link; and initiating a voice link between the wireless device and a device associated with the voice link address.

In another embodiment the invention provides a method for facilitating a user transaction at a user device, the method comprising transferring presentation information to the user device, wherein the presentation information includes a plurality of items; and sending a voice link address to the user device, wherein the voice link address corresponds to a purchasing entity for at least one of the plurality of items.

In another embodiment the invention provides a method for facilitating a transaction, the method comprising obtaining a user identification from an incoming voice link initiation; sending the user identification to a station; receiving selection information from the station; and using the selection information and the initiated voice link to complete a transaction.

In another embodiment the invention provides a method for initiating a voice link over a mobile phone network by using a user device, wherein the user device includes data link capability including web browsing, the method comprising establishing a data link between the user device and a web page server, wherein the web page server includes a web page having a control; using the user device to access the control; selecting the control to indicate a purchase of an item; receiving a phone number via a data link; accepting a signal from the user device to initiate a phone call to the phone number, for purposes of completing a purchase of the item.

In another embodiment the invention provides an apparatus for initiating a voice link in a wireless device, the apparatus comprising a processor; a data link for establishing a data link between the wireless device and a station; a receiver for receiving a machine-readable voice link address from the station to the wireless device over the data link; and a communications process for initiating a voice link between the wireless device and a device associated with the voice link address.

### BRIEF DESCRIPTION OF THE DRAWINGS

FIG. 1 shows basic entities and communications in a preferred embodiment;

FIG. 2 shows a transfer of presentation information in an HTML approach;

FIG. 3 shows a transfer of presentation information in a data file approach;

FIG. 4 shows a display of a scheduling program;

FIG. 5 illustrates basic steps in a process executing at a user's mobile device;

FIG. 6 illustrates basic steps in a process at a content center; and

FIG. 7 illustrates basic steps in a process at a Customer Service Representative center.

### DETAILED DESCRIPTION OF THE INVENTION

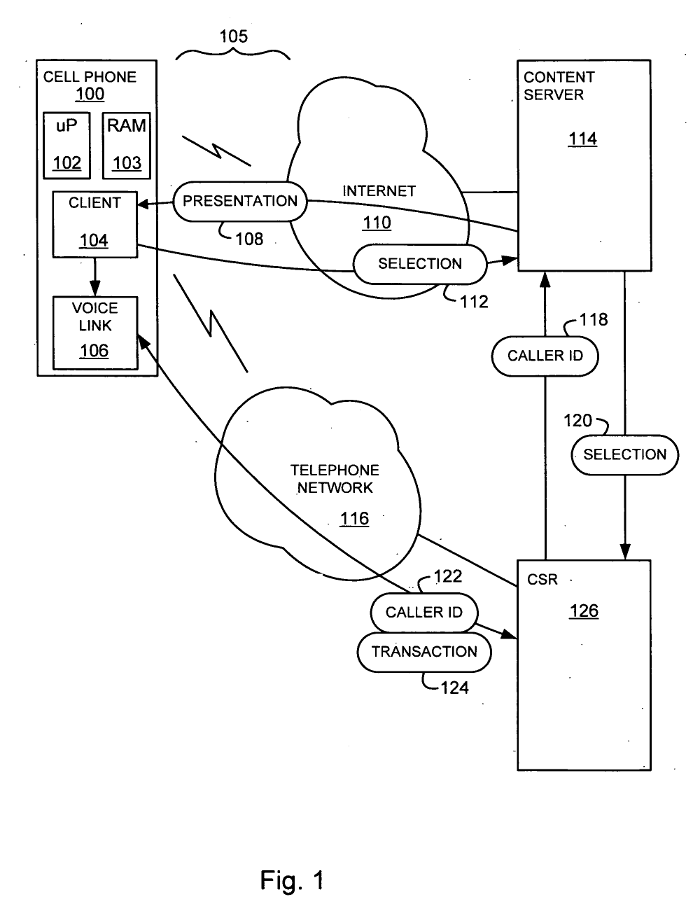

FIG. 1 illustrates basic entities and communications in a preferred embodiment of the invention.

In FIG. 1, a user operates cell phone 100 that includes resources such as processor 102 and random-access memory (RAM) 103 for executing client process 104. Cell phone 100 may include other resources including input/output ports or connectivity, non-volatile storage, etc (not shown). Communications function 106 includes functionality that is typically provided by cell phone devices to establish a communication link such as a voice or data link. Voice and data links can be realized by any practicable approaches such as with Time Division Multiple Access (TDMA), Code Division Multiple Access (CDMA), Global System for Mobile Communication (GSM) or other formats. Note that although specific types of hardware, software or other functionality may be presented, it should be apparent that many variations are possible and are within the scope of the invention. For example, cell phone 100 can be any type of communication device capable of using voice and data links. A PDA, personal computer (PC), wireless transmitter (e.g., radio, intercom, walkie-talkie), or other device can be used. Steps or functions or other actions discussed in connection with the invention may be performed manually, automatically, or by a combination of manual and automated means.

Content server 114 includes an automated system for serving presentation and selection information. For example, content server 114 can be a commercial web page server site that lists items for sale. In general, any type of system or station for providing information can function as a content server. A web page or other presentation information 108 is transferred via Internet 110 to client 104. The presentation information is shown to the user by displaying the items for selection on a display screen as discussed in more detail, below. The user can select which items to purchase by using user interface controls commonly found on a cell phone. For example, the user can use a pointer control and selection button to point and select displayed items. User selection information 112 is sent back to content server 114.

Note that the steps of sending the presentation and selection information occur over a data link connection between the cell phone and the content server. As shown in FIG. 1 at 105, the data link includes wireless communication between the cell phone and Internet 110. Content server 114 is connected to the Internet by a hard-wired link. It should be apparent that any type, or combination of types, of physical communication links can be used. For example, a communication link can include hardwired, radio-frequency, optical, infrared or other types of physical links. Although specific protocols and standards are discussed, or are assumed (e.g., Internet Protocol (IP), HTML, GPRS, etc.) any suitable types of protocols and standards can be used.

After content server presentation and user selection via a data link connection, a voice link connection is initiated by voice link process 106. The voice link connection uses the cellular network shown at 105 and a standard telephone network shown at 116. A typical voice link connection can be a link between a mobile phone and a hardwired phone or “land line.” The voice link connection is used to complete the transaction by placing a user in voice-to-voice communication with a CSR agent at CSR 126. Other embodiments of the invention can use automation at the CSR in whole or in part. For example, a user provided with a voice link to CSR 126 can be presented with a teleprompting menu system to proceed with the transaction.

Once a voice link is established with CSR 126 an identifier in the form of caller ID 122 (or a MIN) is transferred. A preferred embodiment of the invention uses existing caller ID or MIN mechanisms to provide the CSR with the user's caller ID (i.e., the user's cell phone number), MIN or other caller identification information as the call is being initiated. Caller identification can be established in other ways such as the CSR agent asking the user over the voice link for the user's name, phone number, etc. Other possibilities include transferring the caller identification information over the voice link or a supplemental link as, for example, by using an Integrated Services Digital Network (ISDN) or other mechanism. The CSR sends caller identification information 118 to content server 114. Content server uses the caller identification to look up a record of the selection information corresponding to the relevant transaction. Once retrieved, the corresponding selection information 120 is sent back to the CSR. Selection information 120 can be the same as selection information 112 or it can be modified, supplemented, transformed (e.g., encoded or encrypted), etc. In a preferred embodiment, the selection information includes the specific items and other transaction details that were established in the data link session described above.

The CSR or CSR agent takes steps to complete the user transaction as, for example, by obtaining user shipping information, verifying credit card numbers, checking for current user profile information, etc. as indicated by transaction information 124. The CSR benefits from having the user selections already predetermined by the content server and provided in electronic form to the CSR by the content server. In one embodiment a CSR agent is in voice communication with the user. The selection information is transferred to a CSR computer system and the user selections and other relevant information are presented to the CSR agent on a display screen for access while the agent converses with the user.

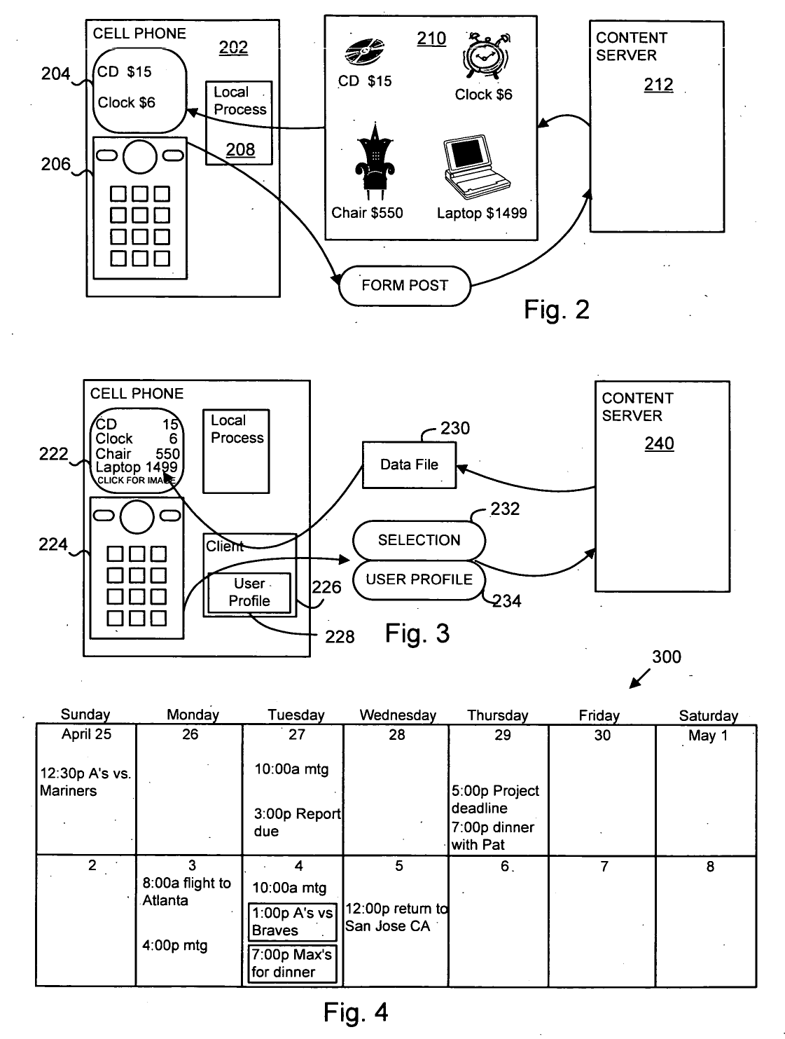

FIG. 2 shows a transfer of presentation information in an HTML approach.

In FIG. 2, cell phone 202 includes display 204, user input controls 206 and local process 208. Local process 208 includes functionality that is typically included in a cell phone, such as the ability to distill and display web pages, accept user selection of items in the web page, etc. Content server 212 provides web page 210 to cell phone 202. In this case, the provision or serving of the web page can be in a standard format. Web page 210 includes various items such as images, text and prices. Each image is an illustration of an item for sale. Each image also has associated descriptive text and a price. A user can select an item for purchase and the selection can be sent back to the content server via standard protocols such as by using a POST operation in an online form.

One problem with serving standard web pages to a small device such as a cell phone is that the cell phone display is not able to efficiently display the much larger web page. In order to alleviate the user from frequent scrolling, zooming or other page manipulations, one approach is to “distill” or otherwise compact the web page information. Usually this includes shrinking or removing the images from the web page. Some systems also provide alternative “thumbnail” or smaller images to be used when a need to display the web page on a small display screen is detected. Provision is also made for accepting user selection of the items via user input controls 206. All of the functionality for distilling, displaying and accepting user input and selection is handled by a process or processes within the cell phone represented by local process 208.

With the standard web page approach of FIG. 2, the display can still be awkward and time-consuming for the user to understand and navigate. For example, the removal or modification of images and distilling of other information on the web page often leads to an unattractive display that can be wasteful of space and hard to follow. Further, some web pages that are designed for input from larger input devices, such as full-size alphanumeric keyboards, may require a user to enter text information such as user name, password, email address, etc. That can be cumbersome to the point where the user does not desire to go ahead with the purchase.

FIG. 3 illustrates a second approach to presentation and selection of transaction items between the content server and user using a data file format.

In FIG. 3, content server 240 sends data file 230 to client process 226 within cell phone 220. Rather than send HTML describing a web page, the format of data file 230 can be any type of format so that very compact and precise information can be sent. Content server 230 can determine what type of items, prices, and other characteristics of a transaction to provide to the cell phone client based on knowledge obtained about the user. For example, if a user has visited a web site before the history of the user's actions, including past purchases can be used to predict the types of items in which the user may be interested.

Another possibility is to use the Extended HTML (XML) protocol. This allows the content server (or another source) to provide graphical user interface (GUI) layer to the user's device once. The GUI layer is then used to display subsequent data such as items and prices without the need to send repeated graphics, page formatting information, etc. Thus, the amount of data needed for transfer is reduced and the data connection can be optimized for bandwidth. The user may get the GUI layer once and then have it filled with necessary values (offerings) and the client software can integrate and render the page. The heavy load of graphical data is reduced and the light weight offerings are pushed using XML. The XML can be formatted HTML POST or GET. First, the html page can be rendered with graphic objects (color & design) and then the item, price and other details can be sent and the html page re-rendered locally.

The data file format can be merely a flat file of item names and prices. The data file information is processed by client 226 and displayed on display screen 222. The act of displaying can include steps performed by a local process (not shown) or other processes within the cell phone. In a preferred embodiment, client 226 is designed to format a compact yet attractive and intelligent presentation of the item and cost information on the small display screen. For example, the items can be arranged in a table format and ordered alphabetically so that a user can use the 12-key keypad provided with every cell phone to search alphabetically for an item name. Since the client, content server, and data file format can all be a new design created by, e.g., the content server owner, any type of data processing and display are possible.

User input for determining a user selection can also be placed under the control of client 226. This could allow a user to cycle through variations of items (e.g., clothing size, ticket date of an event, etc.) by using existing controls (e.g., joystick, wheel, up-down buttons) on a cell phone. In other embodiments, dedicated controls can be provided. A preferred embodiment of the invention includes a special “purchase” button to indicate that one or more previously selected (e.g., highlighted) items on the screen are to be submitted for purchase.

Client 226 can also store user profile 228 that includes identification and purchase information for a specific user. For example, the user's address, full name, credit card number, alternative telephone numbers, etc., can all be included in the user profile. Selection information 232 and user profile 234 are then provided to content server 240 when the user indicates that a selection is completed, or intended for purchase.

One aspect of the invention provides automated suggestion of purchases based on detection of electronic records pertaining to a user's situation. For example, when the initial connection is made from the client to the content server a top-scripted HTML page of the content server can be provided from a link is hard coded on the client. The client can send some information to this server such as location, time, and user profiles that the cell phone has collected from its user which will help the content server's top page decide what type of content presentation to present to the user. The client process or other application can be setup to collect owner information by asking a question every now and then. For example, the cell phone can display and obtain an answer to the question “what is your favorite sport?” This type of information may be used in searching for items of interest on the server to provide the user a more focused offering.

Using the approach of automatically transferring user information between the client process and content server progress can be made toward presenting options to a user without requiring the user to navigate to a web page or otherwise initiate contact with the content server. A user can subscribe to a service so that the client process periodically polls the content server, or any other source of presentation information.

Whenever a client process is in communication with a content server other features can be provided. One such feature includes automatic determination of user desires or interests based on data in existing application programs or utilities. For example, one type of utility provided by portable devices is a “scheduler” program that helps a user to keep track of events to be attended at future times. By uploading the scheduler information to the content server, a process on the content server can analyze the scheduling information and attempt to suggest events in which the user may be interested that the user can simply purchase by activating a selection control.

FIG. 4 shows an enlarged scheduler display 300 that mimics a calendar page in an application running on a portable device, personal computer or other system. Each box corresponds to a day and can have one or more events listed. The entire scheduler information can be automatically provided to the content server when the user visits a web page at the content server. The provision of information can be voluntary (e.g., by express permission by the user) or surreptitious. All or a portion of the scheduling information can be provided. Traditional tools for processing and manipulating the scheduling information can be employed such as synchronization methods to update information among different systems (e.g., cell phone and personal computer). Naturally, the specific display format of the scheduler or calendar application can take on many forms.

In the case of the scheduling information of FIG. 4, an analysis process can determine that the user likes going to baseball games due to the scheduled event on April 25 (and other past games that the user had scheduled (not shown)). The analysis also determines that the user is going to Atlanta, Ga. on May 3^{rd} at 8:00 in the morning. It is also detectable that the user only has a single meeting at 10:00 am on May 4 so that the user may be free in the afternoon and evening of May 4 before the user returns to San Francisco on May 5. In this case the content server sends information to the client that the Oakland A's are playing the Atlanta Braves at 1:00 pm on May 4. This information is displayed in the form of suggestion icon 310. Similarly, suggestion icon 320 is displayed for a restaurant for dinner at 7:00 pm.

The selection of events can use any reasonable criteria. For example, the specific restaurant suggested by suggestion icon 320 can be obtained by checking past restaurants that the user has frequented. A similar type of restaurant can be discovered (e.g., type of food, price range, ambience, etc.). If the user often visits a franchise restaurant in the user's home city (or other locations) the analysis can include a check for a franchise within Atlanta near the ball park. The analysis can also check for a dinner time that is close to the time at which the user typically has dinner. The distance from the ball park can be looked up to make sure that the user can easily go from the ball park to the restaurant. Means of transportation can also be suggested. The distance from the restaurant to the user's hotel room (if detectable) can also be used as a factor to select a restaurant. Many other factors and rules can be used to effectively suggest a user purchase.

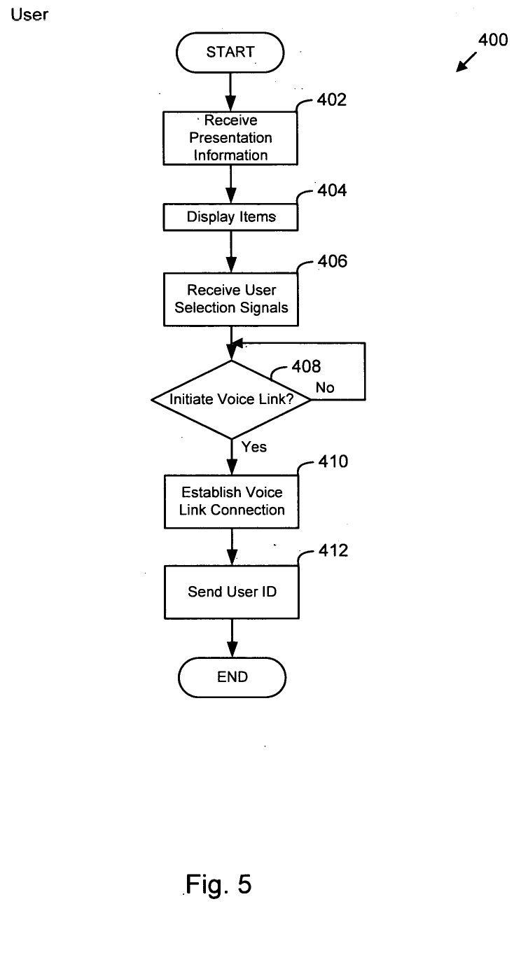

FIG. 5 illustrates basic steps in a process executing at a user's mobile device. In FIG. 5, flowchart 400 is entered when the user has navigated to the content server website. At step 402 presentation information is received at the user's device either via a standard local process or the client process described above. Step 404 displays the presentation information for user selection. At step 406 an indication of user selection is received as, for example, if the user “clicks” on an item on the display.

At step 408 a determination is made whether to initiate a voice link. As described herein, such initiation can be manually as where a user depresses a dedicated button or other control. Initiation can be automatic by using completion of selection of items for purchase as a triggering event. Other approaches are possible such as automatically starting voice link initiation when the user navigates to a web site, initiating a voice link at the request of an administrator at the content provider's or CSR site, etc. A voice link is established at 410. Step 412 is executed to send the user ID to the content center. Any type of information that can be used to identify the user, user device or transaction can be used as the user ID. For example, the “caller ID” of the mobile phone, Internet Protocol (IP) address, Object Identification (OID), component (e.g., central processing unit (CPU)) serial number, etc., could be used alone or in combination.

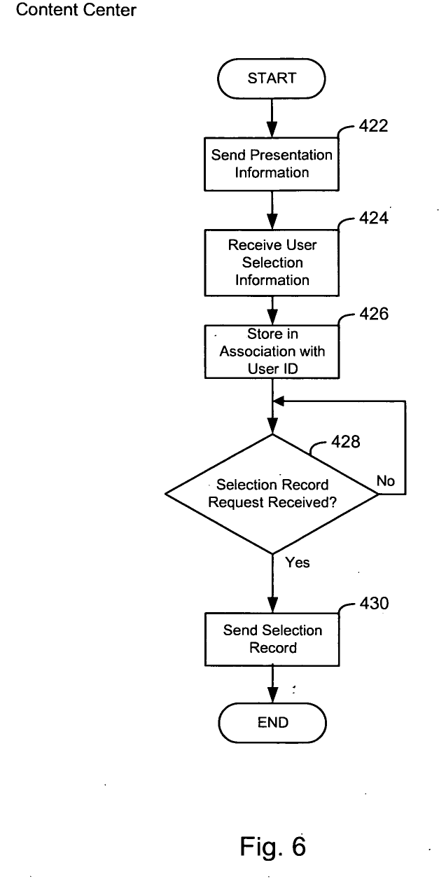

FIG. 6 illustrates basic steps in a process at a content center. In FIG. 6, flowchart 420 is entered when a user has contacted, navigated to, or otherwise accessed information at a content center. Step 422 is executed to send presentation information to the user's device. Next, step 424 is executed when user selection information is received. Step 426 stores the selection information as a record in association with a user identifier, such as the user's caller ID. At step 428 a check is made to determine when a request for the stored selection record is received. After a request for the selection record is received step 430 is performed to send the selection record to the requesting entity (e.g., the CSR).

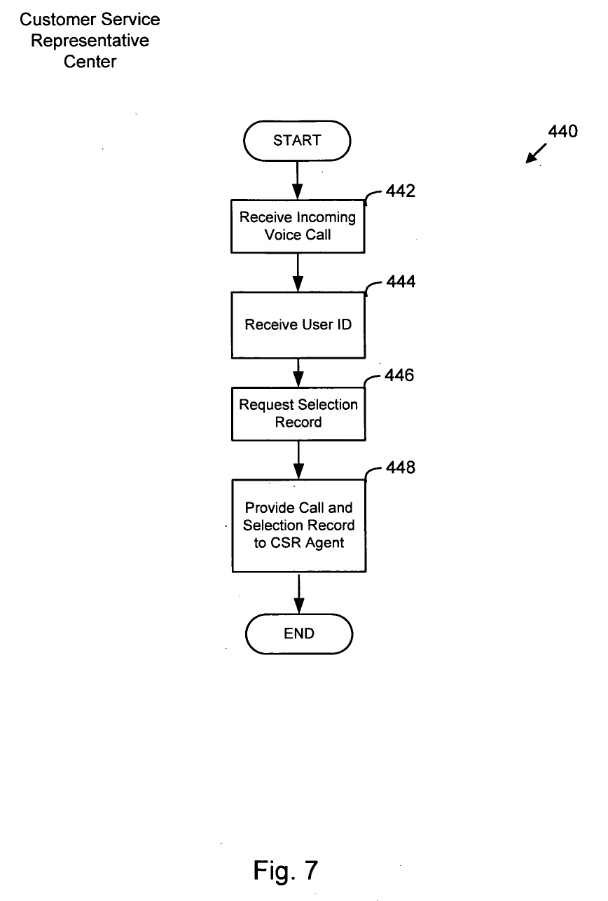

FIG. 7 illustrates basic steps in a process at a CSR. In FIG. 7, flowchart 440 is entered when an incoming phone call (or other voice link) is established with the CSR. A user ID value is received at step 444 and step 446 is performed to request the corresponding selection record from the content center. At step 448 the selection record and voice link are provided to a human agent for completion of the transaction.

Although the invention has been described with respect to specific embodiments thereof, these embodiments are merely illustrative, and not restrictive, of the invention. For example, although the invention has been discussed primarily with respect to the Internet and web page accessing, any type of data communication link and format can be used to provide a user with presentation information about items or services for sale. For example, a data link may be obtained over a voice link by modem. Data can be transferred over a television signal connection or other connection. A voice link connection can be established by using a phone number or any other type of voice link address such as an IP address for voice-over-IP (VoIP) communications, speed-dial number, etc.

Any way of determining a user's whereabouts or actions can be used to assist in suggesting a possible purchase for the user. For example, user “events” such as a user's boarding pass being scanned at a ticket gate for boarding an airplane, entering a subway, train station, etc., can be used to determine that the user is, or will be, at a location. Purchase events such as when a user buys something with a credit card can be determined and the location of the point-of-sale can be logged as the user's location at the time of the event. Such events can use magnetic stripe detection, optical, radio frequency identification (RFID), FeLiCa events, etc.

Although specific steps have been discussed as being performed at different sites or by different entities, such steps may be equally effective if performed at a different location or by a different entity. For example, it is possible that a single entity can perform the steps of the content center and CSR. It may be desirable to have additional entities involved so that the transaction is handled with 3 or more different entities interacting with the user or with the user's device. Many variations are possible.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

Although specific types and numbers of tools, utilities, routines or other programs and functionality has been presented, the functionality provided by embodiments of the invention can be provided by many different design approaches. For example, more or less than six tools can be used. A different ordering of functions (i.e., tool execution) may be desirable in different embodiments. Different designs can include combined functionality of several tools into one, or functions can be allocated to more than six tools. It may be possible and desirable to omit functions described herein in some embodiments. Different embodiments can include more or less automation and more or less manual intervention. Features can be added, deleted, or modified, as, for example, to accommodate future computer operating systems, applications, utilities, drivers or other components.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A method for initiating a voice link in a wireless device, the method comprising
establishing a data link between the wireless device and a station;
receiving a machine-readable voice link address from the station to the wireless device over the data link; and
initiating a voice link between the wireless device and a device associated with the voice link address.

2. The method of claim 1, further comprising
initiating a voice link between the wireless device and a telephone at a customer service representative (CSR) site.

3. The method of claim 1, further comprising
receiving presentation information from the station to the wireless device, wherein the presentation information includes a plurality of items for selection.

4. The method of claim 3, further comprising
determining a user selection of one of the plurality of items.

5. The method of claim 4, further comprising
transferring the user selection to the station.

6. The method of claim 5, further comprising
using a caller identification (caller ID) feature to provide the voice link address to the CSR site.

7. The method of claim 1, wherein the wireless device includes a mobile phone.

8. The method of claim 1, wherein the wireless device includes a personal digital assistant.

9. The method of claim 1, wherein the wireless device includes a laptop.

10. The method of claim 1, wherein the voice link address includes a telephone number.

11. The method of claim 1, wherein the voice link address includes a voice-over-Internet Protocol address.

12. The method of claim 1, wherein the voice link address includes a uniform resource locator (URL).

13. The method of claim 1, wherein “initiating” includes
detecting a signal from a dedicated control activated by a user.

14. The method of claim 3, wherein “initiating” is in response to
detecting a signal from a user input device to indicate a completion of selection of the plurality of items.

15. The method of claim 1, wherein “initiating” includes
terminating the data link.

16. A method for facilitating a user transaction at a user device, the method comprising
transferring presentation information to the user device, wherein the presentation information includes a plurality of items; and
sending a voice link address to the user device, wherein the voice link address corresponds to a purchasing entity for at least one of the plurality of items.

17. The method of claim 16, further comprising
receiving a selection from the user device to select an item;
storing the selection as a selection record;
receiving a user identification from the purchasing entity;
determining that the selection record is associated with the user identification; and
providing the selection record to the purchasing entity.

18. The method of claim 16, wherein the user identification includes a telephone number.

19. A method for facilitating a transaction, the method comprising
obtaining a user identification from an incoming voice link initiation;
sending the user identification to a station;
receiving selection information from the station; and
using the selection information and the initiated voice link to complete a transaction.

20. The method of claim 19, wherein the user identification includes a telephone number.

21. The method of claim 20, further comprising
obtaining the telephone number via a caller identification (caller ID) feature.

22. A method for initiating a voice link over a mobile phone network by using a user device, wherein the user device includes data link capability including web browsing, the method comprising
establishing a data link between the user device and a web page server, wherein the web page server includes a web page having a control;
using the user device to access the control;
selecting the control to indicate a purchase of an item;
receiving a phone number via a data link;
accepting a signal from the user device to initiate a phone call to the phone number, for purposes of completing a purchase of the item.

23. A method for initiating a voice link over a mobile phone network, the method comprising
establishing a data link between a server and a user device;
receiving information from a seller site to determine an item for sale;
using the server to provide a web page to the user device, wherein the web page includes a control for initiating a purchase of the item;
determining activation of the control;
in response to determining activation of the control, sending a phone number to the user device, wherein the phone number is associated with the seller site for creation of a voice link between the seller site and the user to complete a purchase of the item.

24. A method for providing scheduling information to a user device, the method comprising
establishing a data link connection between the user device and a server;
transferring scheduling information from the user device to the server;
determining that at least one time slot in the scheduling information is free; and
sending an indicator of a suggested appointment to the user device.

25. The method of claim 24, further comprising
displaying an icon in a displayed slot of a displayed calendar on the user device.

26. The method of claim 24, further comprising
determining a user's position.

27. The method of claim 26, wherein determining includes
determining a user's position using global positioning system (GPS) information.

28. The method of claim 26, wherein determining includes
determining a user's position using scheduling information.

29. The method of claim 26, wherein determining includes
determining a user's position using email information.

30. The method of claim 26, wherein determining includes
determining a user's position using event detection.

31. The method of claim 30, wherein an event includes boarding an airplane.

32. The method of claim 30, wherein an event includes scanning a ticket associated with the user.

33. The method of claim 30, wherein an event includes radio frequency identification (RFID) detection.

34. The method of claim 30, wherein a FeLiCa event is detected.

35. An apparatus for initiating a voice link in a wireless device, the apparatus comprising
a processor;
a data link for establishing a data link between the wireless device and a station;
a receiver for receiving a machine-readable voice link address from the station to the wireless device over the data link; and
a communications process for initiating a voice link between the wireless device and a device associated with the voice link address.

36. A machine-readable medium including instructions for initiating a voice link in a wireless device, the machine readable medium comprising
one or more instructions for establishing a data link between the wireless device and a station;
one or more instructions for receiving a machine-readable voice link address from the station to the wireless device over the data link; and
one or more instructions for initiating a voice link between the wireless device and a device associated with the voice link address.
